(19) United States
(12) Patent Application Publication
(10) Pub. No.: US 2002/0180998 A1
(43) Pub. Date: Dec. 5, 2002

(54) Methods and arrangements for calibrating a color printing device using multi-dimensional look-up tables

(76) Inventor: Yifeng Wu, Vancouver, WA (US)

Correspondence Address: HEWLETT-PACKARD COMPANY, Intellectual Property Administration, P.O. Box 272400, Fort Collins, CO, 80527-2400, US

(21) Appl. No.: 09/875,248

(22) Filed: Jun. 5, 2001

(51) Int. Cl. B41J 1/00; G06F 15/00

(52) U.S. Cl. 358/1.9; 358/504

(57) ABSTRACT

A tiered calibration process is provided for use in color printing devices. A first tier calibration or coarse calibration is performed based on measured luminance values from a test print. If the measured values are different than the desired values, then linearization parameters maintained in one-dimensional look-up tables are modified to reduce the difference. A second tier calibration or fine calibration is then performed based on measured luminance and chrominance values in a subsequent test print. If the measured values are different than the desired values, then the applicable color conversion parameters maintained in a multi-dimensional look-up table are modified to reduce the difference. The fine calibration may also be conducted without having performed the coarse calibration.

### TECHNICAL FIELD

The present invention relates generally to color printing devices, and more particularly to methods and arrangements for calibrating the colors that are printed by the color printing devices.

### BACKGROUND

Color printing devices, such as, e.g., color printers and copiers, have continued to evolve with the electronics, computing and communication industries. Along the way there have been several different types of color printing devices. Currently, color ink jet printing devices and color laser printing devices are the most common. Regardless of the type of color printing device, there is a continuing need to provide consumers with devices that can consistently reproduce or mark a specified print media with the desired color(s). Most often, the desired colors are created using a specific combination of inks/toners/etc., i.e., marking materials. The reproduced image includes a plurality of dots, wherein each dot has a distinct color when applied.

In a computing environment, for example, one or more dots are associated with each pixel as provided in the computer's display memory and displayed on a monitor. Typically, each pixel is associated with several dots. The area associated with certain dots often overlaps the area of neighboring dots, and vice versa. Indeed, certain types of marking materials are designed to further mix or combine shortly after being applied to the print media.

There are several factors that can influence the final color that is printed. Firstly, there can be physical/chemical differences in the marking materials, e.g., inks, toners, and the like, which are replenished from time to time. The physical/chemical differences in the marking materials may result in visually noticeable changes in the final printed color.

Secondly, for example, in certain ink jet printing devices the print head mechanism may require replacement. A typical print head includes one or more ink jet nozzles. The openings of these nozzles may vary in size within a print head or from one print head to the next, either intentionally or unintentionally. The size of the opening of the nozzle is related the size of the ink drop produced and applied to the print medium. Hence, variations in the size of the opening of the nozzle may affect the final printed color.

Thirdly, changes in environmental factors, such as, for example, the temperature and/or humidity, may alter the performance of the printing mechanism, the marking materials, and/or the print media. Thus, environmental changes may also affect the final printed color.

Consequently, to maintain color consistency over time and/or between different printing devices, there is a need to account for these and other changing factors. This is typically accomplished by calibrating or otherwise adjusting the color printing device at various times or as needed.

The changing factors, for example as described-above, tend to cause a change in the luminance of each primary printing color (e.g., CMYK, etc.). Traditional printer calibration processes identify such luminance changes by measuring the optical density of selected color images (e.g., test images or color patches). The selected color images usually include a plurality of patches of discrete color ramps of the primary printing colors. Based on detected changes in the measured optical density, certain operational parameters are adjusted to reproduce colors that are closer to referenced color values.

By way of example, in certain color printing devices linearization parameters are modified to account for changes in the measured optical density. The linearization parameters are typically provided in a plurality of one-dimensional look-up tables (1D-LUTs). Each 1D-LUT is associated with a particular primary printing color marking material, e.g., CMYK inks or toners. These 1D-LUTs are basically used in a linearization process to correct specified color values prior to halftoning and eventual printing.

Such calibration/linearization processes are particularly useful when the ink jet nozzles are changed, e.g., when the pen drop weight is varied. However, these calibration/linearization processes have some drawbacks. For example, these methods do not detect nor correct changes in the chrominance of the printed color. A tone or hue shift such as this can occur when the ink cartridge in an ink jet printer is changed and the new ink is slightly different from the old ink. Thus, a change in the hue of a color will not be compensated for by a linearization method. Likewise, conventional linearization methods cannot adequately account for changes in the chrominance due to environmental factors, e.g., temperature and humidity.

Consequently, there is need for improved methods and arrangements for calibrating color printing devices. Preferably, the improved methods and arrangements will correct both the luminance and chrominance of the printed colors or at least a portion of the printed colors.

### SUMMARY

Improved methods and arrangements are provided for calibrating color printing devices, based on detected luminance and chrominance changes in at least a portion of the printed colors.

Theoretically, color can be represented as a multi dimensional quantity. Consequently, color variation can be represented by parameters within a multi-dimensional data structure. In accordance with certain aspects of the present invention, therefore, multi-dimensional look-up tables or similar multi-dimensional data structures are utilized to provide increased control over the color calibration process.

By way of example, the above stated needs and others are met by a tiered calibration process for use in a printing device, in accordance with certain exemplary implementations of the present invention. A first tier calibration or coarse calibration is performed based on measured luminance values from a test print. If the measured values are different than the desired values, then linearization parameters are modified to reduce the difference. This step only calibrates the luminance changes of the primary printing colors. A second tier calibration or fine calibration is then performed based on measured chrominance and luminance values (e.g., colorimetric values such as CIE L*a*b*, or CIE XYZ) in a subsequent test print. If the measured values are different than the desired values, then the applicable color conversion parameters are modified to reduce the difference. In certain implementations, the fine calibration advantageously uses a multi-dimensional look-up table to calibrate both the chrominance and luminance in the printed colors.

### BRIEF DESCRIPTION OF THE DRAWINGS

A more complete understanding of the various methods and arrangements of the present invention may be had by reference to the following detailed description when taken in conjunction with the accompanying drawings wherein:

FIG. 1 is a block diagram depicting a printing device capable of performing a tiered color calibration process using the color conversion capabilities of multi-dimensional look-up tables (MLUTs), in accordance with certain exemplary implementations of the present invention.

FIG. 2 is a flow diagram illustrating a two-tiered color calibration process suitable for use in the printing device of FIG. 1, in accordance with certain exemplary implementations of the present invention.

FIG. 3 is a block diagram depicting a color imaging pipeline process of the printing device of FIG. 1, in accordance with certain exemplary implementations of the present invention.

FIG. 4 is a block diagram depicting the use of multi-dimensional look-up tables during color calibration of the printing device of FIG. 1, in accordance with certain exemplary implementations of the present invention.

FIG. 5 is a block diagram further depicting the modification of selected values in a multi-dimensional look-up table that is configured to provide color matching during printing, based on the color calibration process depicted in FIG. 4, in accordance with certain exemplary implementations of the present invention.

### DETAILED DESCRIPTION

Improved methods and arrangements are provided for calibrating color printing devices, based on detected luminance and chrominance changes in at least a portion of the printed colors. While the following description describes certain exemplary implementations in the form of a color ink jet printer, it should be understood that the various methods and arrangements provided herein can be applied to other color printing devices, such as, for example, a color laser printer, a color copier, a color facsimile machine, or the like.

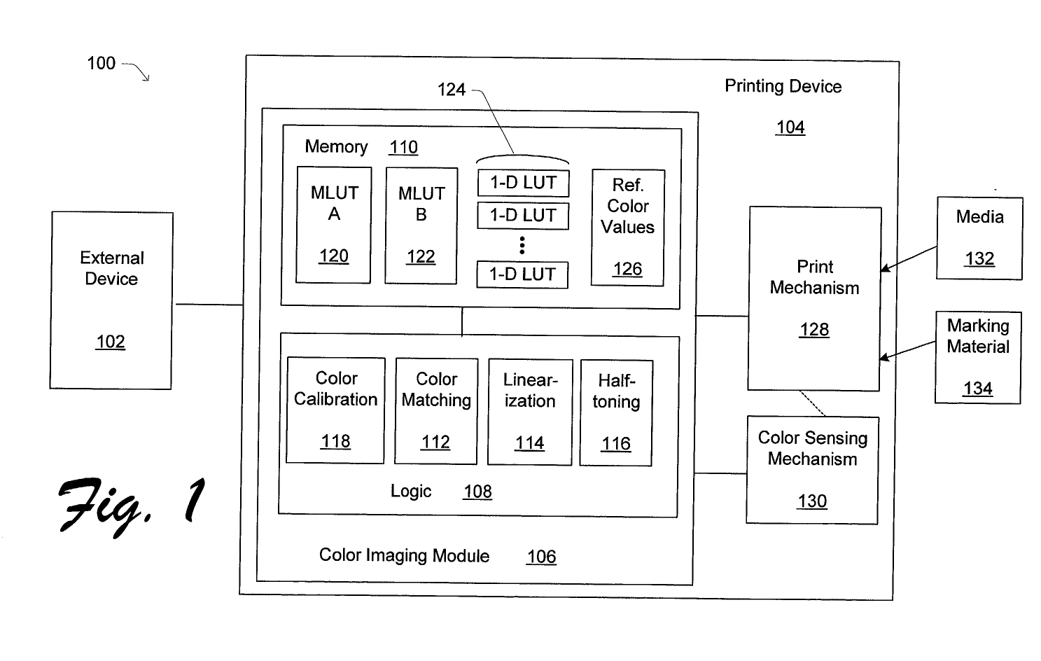

With this in mind, attention is drawn to FIG. 1, which is a block diagram depicting a conventional networked printing arrangement 100. In this example, an external device 102 is operatively coupled to a color printing device 104. External device 102 represents any device that is capable of communicating image information to color printing device 104. In a typical implementation, external device 102 would be a computer or server.

As shown, color printing device 104 includes a color imaging module 106. Color imaging module 106 includes logic 108, which is operatively coupled to a memory 110. As used herein, the term logic is meant to broadly include hardware, software, firmware, or any combination thereof that is configured accordingly.

Here, logic 108 includes color matching logic 112, linearization logic 114, halftoning logic 116, and color calibration logic 118. The functionality of color matching logic 112, linearization logic 114 and color calibration logic 118 are described in greater detail below. The functionality of halftoning logic 116 is well understood by those skilled in the art, and as such is not described in detail.

Color matching logic 112 is basically used to convert one type of formatted color image data into another type of formatted color image data. For example, in accordance with certain implementations of the present invention, color matching logic 112 converts Red-Green-Blue (RGB) image data, which was initially provided by external device 102, into corresponding Cyan-Magenta-Yellow-Black (CMYK) image data. The output from color matching logic 112 is provided to linearization logic 114, which is operatively configured to correct the image data. Thus, in the example above, CMYK data, or other like data, can be selectively modified to correct for detected luminance changes of each printed primary color. The output from linearization logic 114 is then provided to halftoning logic 116, which further processes the image data and outputs corresponding half toned (binary) image data suitable for printing.

As described in greater detail below, color calibration logic 118 is operatively configured to selectively modify: (a) the linearization parameters utilized by linearization logic 114 in response to detected changes in the luminance of one or more primary printing color test patches printed on a print out; (b) the conversion parameters utilized by color matching logic 112 in response to detected changes in both luminance and chrominance of additional test patches printed on a print out. This exemplary arrangement provides for a two-tier calibration process. In the first tier, the linearization parameters are calibrated, as part of a “coarse calibration” process. In the second tier, the color conversion parameters are calibrated as part of a “fine calibration” process. Preferably, this fine calibration process provides farther adjustments based on detected chrominance changes in a second test printing with different test patches that have benefited from the first tier, coarse calibration process.

In a coarse calibration process, a plurality of test patches of the primary printing colors, in different gray levels, are used. In a fine calibration process, a different plurality of test patches consisting of a mixture of primary printing colors is used. These fine calibration test patches relate to at least one specified zone of interest within the color space.

The reference tables may be obtained, for example, by printing predefined test targets under nominal printing conditions. This means that the targets should be printed using nominal drop weight pens, standard inks/toners, a reference color map (as a multi-dimensional look-up table), linearization tables (a set of one-dimensional look-up tables), and under nominal temperature and humidity conditions.

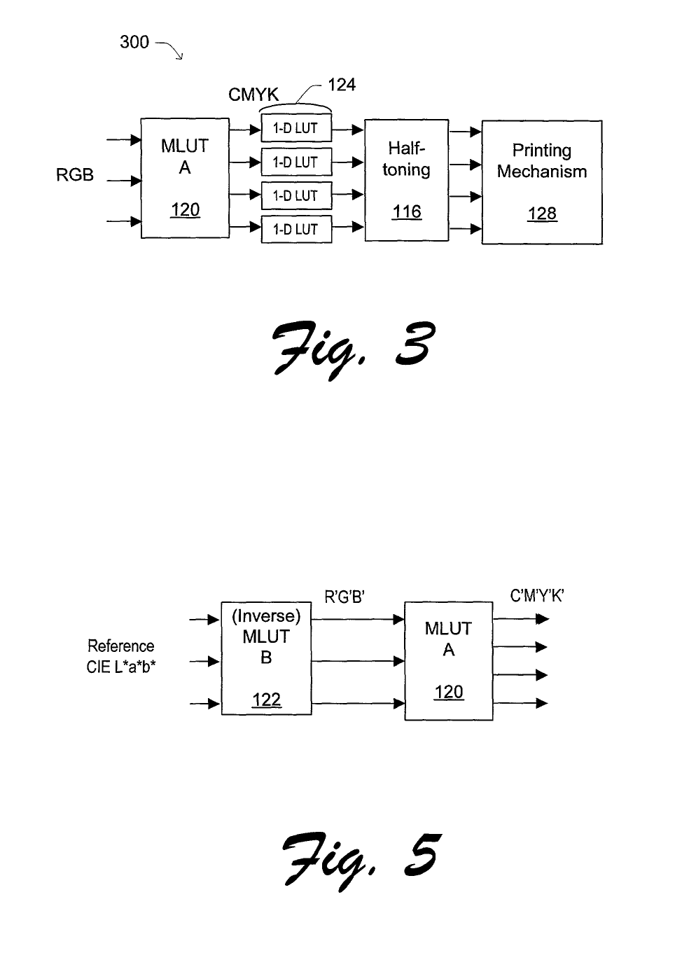

Certain data collections or data tables are illustratively depicted within memory 110. The use of these data collections will become more apparent in the description associated with FIGS. 3-5. In this exemplary implementation, the data collections includes two multi-dimensional look-up tables (MLUT), namely MLUT “A” 120 and MLUT “B” 122. MLUT A 120 and MLUT B 122 include color conversion parameters.

MLUT A 120 is accessed by color matching logic 112. Thus, for example, in certain implementations MLUT A 120 is a three dimensional lookup table that includes CMYK conversion parameters that are operatively identified by an incoming RGB triplet. In certain implementations, for example, the size of MLUT A 120 is 9³, 17³ or 33³. The conversion parameters within MLUT A 120 may be modified by color calibration logic 118 during a fine calibration process.

MLUT B 122 is accessed by color calibration logic 118 during a fine calibration process. Thus, for example, in certain implementations MLUT B 122 is a three dimensional look-up table that includes CIE L*a*b* triplet conversion parameters, defined by the Commission Internationale de l'Eclairage (CIE), that are operatively identified by incoming RGB triplets. The conversion parameters within MLUT B 122 are provided by luminance and chrominance data, e.g., calorimetric data, measured by color sensing mechanism 130.

Those skilled in the art will recognize other color conversion schemes can be implemented. Hence, the size/dimensions of MLUT A 120 and MLUT B 122 may change. Also, it is understood that other comparable data structures may be used.

Reference color values 126 are also provided within memory 110. To support coarse calibration, for each primary printing color (e.g., CMYK), there is a reference curve that defines the optical density for the respective color. To support fine calibration, a list of corresponding reference values between input RGB and output CIE L*a*b* is provided.

Referring to FIG. 1 again, color printing device 104 further includes a print mechanism 128, which is operatively coupled to color imaging module 106 and configured to receive print commands there from and selectively apply one or more marking materials 134 to a print media 132. Thus, for example, during a coarse calibration process, print mechanism 128 will print a plurality of color test patches. These color test patches are monitored or otherwise sensed by a color sensing mechanism 130. For a coarse calibration process, color sensing mechanism 130 is configured to sense the luminance of one or more of the primary printing color patches. During a subsequent fine calibration process, print mechanism 128 will print a different plurality of color test patches. Here, color sensing mechanism 130 is configured to sense the chrominance and luminance (e.g., calorimetric values) of the color patches.

Those skilled in the art will recognize that color sensing mechanism 130 may have one or more conventional optical sensing devices arranged to sense the luminance and chrominance of certain test patches. For example, in certain implementations, a calorimeter is arranged to sense the test patches and generate corresponding CIE L*a*b* values.

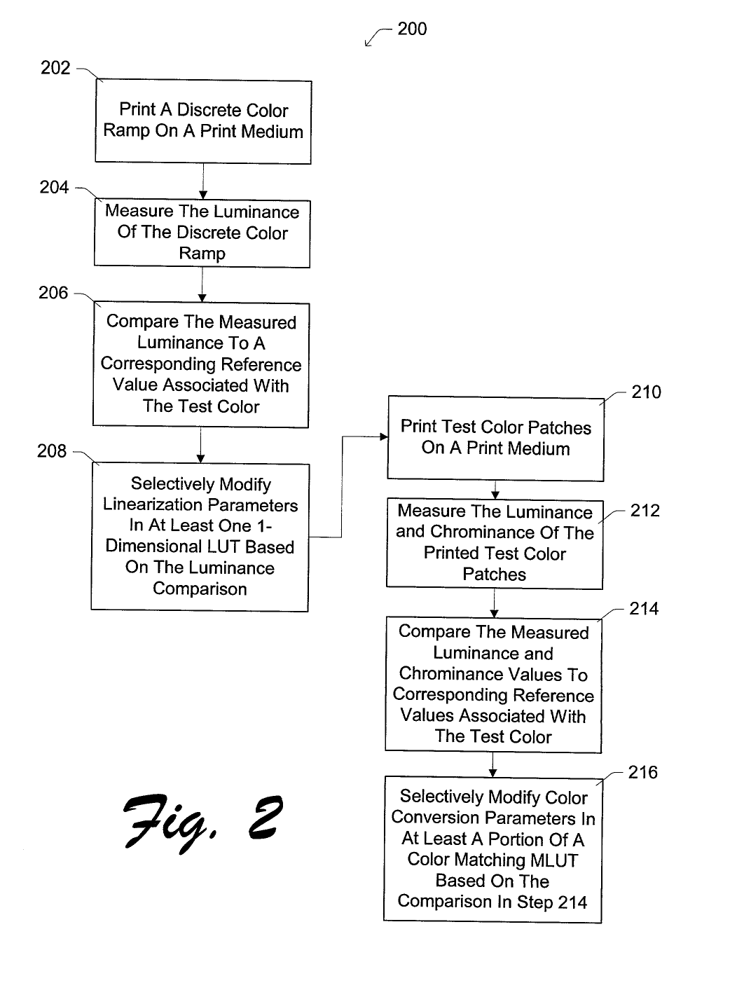

With this in mind, attention is now drawn to FIG. 2, which is a flow diagram depicting a two-tier calibration process 200 that is suitable for use in printing device 104 of FIG. 1. Steps 202 through 208 provide a first tier color calibration (e.g., a coarse calibration). Steps 210 through 216 provide a second tier color calibration (e.g., a fine calibration).

In step 202, color test patches are printed on a print medium, e.g., paper. In step 204, the luminance (optical density) of discrete color ramp is measured. Next, in step 206, the measured luminance values are compared to defined reference values associated with the respective color test patches. If the difference between the reference value and the measured value is significant enough that it can or should be corrected, then in step 208, one or more of the linearization parameters are modified to account for (i.e.,. reduce) the difference.

In step 210, another test patch print out is made. The test patches printed on this print out may be different from the print out in step 202. In step 212, the calorimetric values of certain color test targets or pages are measured. Next, in step 214, the measured colorimetric values are compared to defined reference values associated with the respective color test patches. If the difference between the reference value and the measured value is significant enough that it can or should be corrected, then in step 216, one or more of the color conversion parameters are modified to account for (i.e.,. reduce) the difference.

The following description provides additional details associated with certain exemplary implementations of the present invention.

Reference is now made to FIG. 3, which is a block diagram depicting a color printing pipeline arrangement 300. In this example, it is assumed that the input to the pipline is a contone image in RGB color space. This RGB data is used by color matching logic 112 to access MLUT A 120. In this manner, MLUT A 120 converts the RGB image data into corresponding CMYK image data. The resulting CMYK image data is then provided to linearization logic 114, which utilizes 1-D LUTs 124 to make corrections to the CMYK values that correct the optical density of the printed image. The corrected CMYK image data is then provided to halftoning logic 116, whereing the corrected CMYK image data is converted into a corresponding binary image for the purpose of printing.

Here, 1-D LUTs 124 are used to calibrate for luminance variations, and MLUT A 120 is used to calibrate for chrominance variations as well as the residue of the luminance calibration.

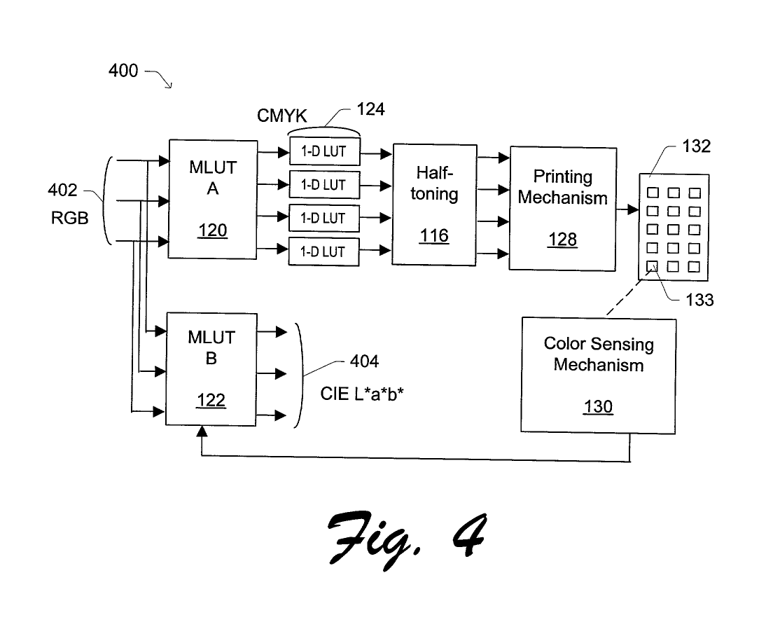

FIG. 4 is a block diagram depicting the above pipeline during an exemplary color calibration process. Here, a color test patch 133 is printed on medium 132, per RGB inputs 402. The RGB value of each resulting color patch is known. Color sensing mechanism 130 is used to measure the L*a*b* values of each color patch. The result of the measurements is then used to construct a MLUT B 122. Here, MLUT B 122 provides a conversion from RGB color space to L*a*b* color space. The result from MLUT B 122 is L*a*b* values 404.

FIG. 5 is a block diagram illustrating a color calibration process. Here, defined reference L*a*b* values are used to access MLUT B 122. MLUT B 122 is thusly, used to perform an inverse interpolation. Hence, for each reference L*a*b* triplet a corresponding RGB triplet is located in MLUT B 122. The result of this inverse interpolation provides R′G′B′ values. If the R′G′B′ values are different from the RGB values originally defined by the reference, then there is some deviation from the reference and calibration is required. Then the R′G′B′ values are provided as the inputs to M LUTA 120, which is used to perform a forward interpolation to obtain corresponding C′M′Y′K′ values. These C′M′Y′K′ values are used to replace the original CMYK values in MLUT A 120 while the input is RGB. In this way the L*a*b* values under the current printing conditions, as measured by sensing mechanism 130, are used to calibrate the color matching module MLUT A 120.

In certain cases the calibrations can be applied to the entire color space. However, in accordance with certain implementations of the present invention, the calibration processes focus on only a portion of the color space. For example, special zones can be defined that include , e.g., neutral axis, skin tone(s), etc. Thus, only a portion of MLUT A 120 will be modified.

Thus, although some preferred embodiments of the various methods and arrangements of the present invention have been illustrated in the accompanying Drawings and described in the foregoing Detailed Description, it will be understood that the invention is not limited to the exemplary implementations disclosed, but is capable of numerous rearrangements, modifications and substitutions without departing from the spirit of the invention as set forth and defined by the following claims.

What is claimed is:

1. A method for automatically calibrating a color printing device, the method comprising:
performing a luminance calibration for at least one printing primary color; and
performing a combined luminance and chrominance calibration for at least one color comprising the at least one printing primary color.

2. The method as recited in claim 1, wherein performing the luminance calibration includes performing a linearization parameter calibration.

3. The method as recited in claim 2, wherein the linearization parameter calibration includes:
printing primary printing color test patches on a print medium;
measuring a luminance value associated with the primary printing color test patches;
comparing the measured luminance value with a defined reference value; and
modifying at least one linearization parameter based on the comparison.

4. The method as recited in claim 3, wherein the linearization parameter is operatively associated with a one-dimensional look-up table.

5. The method as recited in claim 1, wherein performing the combined luminance and chrominance calibration includes performing a color conversion parameter calibration.

6. The method as recited in claim 5, wherein the color conversion parameter calibration includes:
printing color test patches on a print medium;
measuring luminance and chrominance values associated with the color test patches;
interpolating between the measured luminance and chrominance values based on defined reference values; and
modifying color conversion parameters based on the interpolation.

7. The method as recited in claim 6, wherein the color conversion parameters are operatively associated with a multi-dimensional look-up table.

8. The method as recited in claim 1, wherein performing the luminance calibration occurs prior to performing a combined luminance and chrominance calibration.

9. A color printing device comprising:
a color imaging module configurable to generate selected print commands;
a print mechanism operatively coupled to the color imaging module and configurable to print different test color patches in response to the selected print commands; and
a color sensing mechanism operatively coupled to the print engine and operatively configurable to measure luminance and chrominance values of the different test color pages, and
wherein the color imaging module is further configurable to be calibrated against a defined reference state by conducting:
a luminance calibration based on a comparison of the measured luminance and defined corresponding luminance reference values, and
a combined luminance and chrominance calibration based on a comparison of the measured luminance and chrominance and defined corresponding combined luminance and chrominance reference values.

10. The color printing device as recited in claim 9, wherein the color imaging module further includes:
memory; and
logic operatively coupled to the memory and configured to:
perform the luminance calibration such that at least one linearization parameter stored in the memory is modified, and
perform the combined luminance and chrominance calibration such that at least one color conversion parameter stored in the memory is modified.

11. The color printing device as recited in claim 10, wherein the linearization parameter is maintained in a 1-dimensional look-up table.

12. The color printing device as recited in claim 10, wherein the color conversion parameter is maintained in a multi-dimensional look-up table.

13. A method for automatically calibrating a color printing device, the method comprising:
printing color test patches on a print medium;
measuring luminance and chrominance values associated with the color test patches;
interpolating between the measured luminance and chrominance values based on defined reference values; and
modifying color conversion parameters based on the interpolation.

14. The method as recited in claim 13, wherein the color conversion parameters are operatively associated with a multi-dimensional look-up table.

15. A color printing device comprising:
a color imaging module configurable to generate selected print commands;
a print mechanism operatively coupled to the color imaging module and configurable to print different test color patches in response to the selected print commands; and
a color sensing mechanism operatively coupled to the print engine and operatively configurable to measure luminance and chrominance values of the different test color pages, and
wherein the color imaging module is further configurable to be calibrated against a defined reference state by conducting a combined luminance and chrominance calibration based on a comparison of the measured luminance and chrominance and defined corresponding combined luminance and chrominance reference values.

16. The color printing device as recited in claim 15, wherein the color imaging module is further configurable to be calibrated against a defined reference state by conducting a luminance calibration based on a comparison of the measured luminance and defined corresponding luminance reference values.

17. The color printing device as recited in claim 16, wherein the color imaging module further includes:
memory; and
logic operatively coupled to the memory and configured to:
perform the luminance calibration such that at least one linearization parameter stored in the memory is modified, and
perform the combined luminance and chrominance calibration such that at least one color conversion parameter stored in the memory is modified.

18. The color printing device as recited in claim 17, wherein the linearization parameter is maintained in a 1-dimensional look-up table.

19. The color printing device as recited in claim 17, wherein the color conversion parameter is maintained in a multi-dimensional look-up table.

20. A color printing device comprising:
color matching logic arranged to convert color image data from a first format to a second format using a programmable multi-dimensional data structure; and
calibration logic coupled to the color matching logic and configured to program the multi-dimensional data structure when the color matching logic causes a printed color to deviate from an expected color.

21. The color printing device as recited in claim 20, further comprising:
linearization logic coupled to the color matching logic and the calibration logic and configured to apply a programmable correcting value to at least a portion of the converted image data and output corrected image data, and
wherein the calibration logic is further configured to program the correcting value when the linearization logic causes the printed color to deviate from a reference color.

22. The color printing device as recited in claim 20, wherein the calibration logic is configured to program the multi-dimensional data structure when measured luminance and chrominance values of the printed color significantly deviate from combined luminance and chrominance values of certain expected colors.

23. The color printing device as recited in claim 21, wherein the calibration logic is configured to program the correcting value when a measured luminance value of the printed color significantly deviates from a luminance value of certain expected primary printing colors.

24. The color printing device as recited in claim 20, further comprising:
a color sensing mechanism operatively coupled to the calibration logic and configured to determine a luminance value and a chrominance value of the printed color.

25. A tiered calibration method for use in a color printing device, the method comprising:
performing a first tier calibration based on measured luminance values from a test print, wherein if the measured luminance values are different than corresponding desired luminance values, then associated linearization parameters are modified to reduce the luminance value difference; and
performing a second tier calibration based on measured luminance and chrominance values in a subsequent test print, wherein if the measured luminance and chrominance values are different than corresponding luminance and chrominance desired values, then associated color conversion parameters are modified to reduce the luminance and chrominance value differences.
